(19) United States
(12) Patent Application Publication
(10) Pub. No.: US 2026/0265144 A1
(43) Pub. Date: Sep. 10, 2026

(54) REDUCING MIXER BUILDUP OF BINDER MATERIAL THROUGH STAGED ADDITION OF RAW MATERIALS

(71) Applicant: UNITED STATES GYPSUM COMPANY, Chicago, IL (US)

(72) Inventors: Gopakumar Kaladharan, Mundelein, IL (US); James Brendan O'Sullivan, Lake Zurich, IL (US); Richard Zhengjun Liu, Palatine, IL (US)

(73) Assignee: UNITED STATES GYPSUM COMPANY, Chicago, IL (US)

(21) Appl. No.: 19/266,969

(22) Filed: Jul. 11, 2025

Related U.S. Application Data
(60) Provisional application No. 63/768,217, filed on Mar. 7, 2025.

(51) Int. Cl. C04B 28/14; C04B 14/18; C04B 18/02; C04B 20/10; C04B 40/00; C04B 103/30; C04B 111/00

(52) U.S. Cl. CPC C04B 28/14; C04B 14/185; C04B 18/027; C04B 20/10; C04B 40/0046; C04B 2103/304; C04B 2111/00612

(57) ABSTRACT

A method of making a rapid setting binder composition is provided by adding the liquids and solids to a mixer and once homogeneously mixed, adding expanded perlite. This method reduces the buildup in the mixer and is more efficient than the prior art methods. Products made using the method are also provided.

### FIELD OF THE INVENTION

Rapid setting, lightweight binder compositions often comprise materials which become sticky when wetted out in the manufacturing process, for example stucco (calcium hemihydrate), and other reactive powders in liquids, which are mixed to a homogeneous paste.

The present invention lessens mixer build-up when manufacturing rapid setting binder compositions, resulting in fewer delays in manufacturing and more efficient processing.

### BACKGROUND OF THE INVENTION

Mixer buildup is one of the key challenges with the manufacture of rapid setting binder compositions, causing inefficiencies and requiring downtime for cleaning of the mixer. The binder compositions cause significant buildup on the mixer parts and plug or partially plug the ports that supply the liquids to the mixer.

The prior art methods of making rapid setting binder compositions are continuous methods utilizing an inline mixer, which comprises moving parts and numerous inlet ports into the mixer. U.S. patent Ser. No. 11/224,990 teaches examples of such mixers, preferably a single pass horizontal continuous mixer.

In the prior art methods of making the rapid setting binder composition, the solids and the expanded perlite are supplied to the mixer inlet and then the liquids are added to the mixer. In these binders, stucco is present in the solids, stucco becomes stuck to the mixer parts while the stucco is wetting out. Stucco is very sticky and sets fast. Binders with stucco take longer to be dispersed into the liquids as a paste as compared to other binders without stucco. This causes significant mixer buildup.

Some components of rapid setting binder compositions become sticky when being homogenized with liquids into a paste (for example stucco) while other components do not develop sticky properties in the mixing process (for example expanded perlite). When the amount of liquids provided is not sufficient for rapid dispersion of the sticky components into a paste, portions of the sticky components attach themselves to the mixer parts and inlets and harden. This results in inefficiencies due to frequent required shutdowns to remove the portions of the sticky components from the mixer parts and inlets, or worse equipment breakdowns due to accumulations on the mixer parts and inlets.

DE2207933, herein incorporated by reference in its entirety, teaches using a multistage mixer with different inlets for various components. The perlite with other components was added at numerous locations in the process with the goal of lowering the amount of water in the composition.

WO2023126069, herein incorporated by reference in its entirety, teaches at least a two-stage mixer, where the speed of mixing is varied for the addition of different components.

PL438019, herein incorporated by reference in its entirety, teaches adding foamed glass with perlite and other components to make lightweight concrete.

U.S. Pat. No. 8,057,915, herein incorporated by reference in its entirety, teaches combining dry components first and then adding the mixture to water.

U.S. Pat. No. 2,980,548 teaches using a wetting anti-foaming agent to address the stickiness of binders, which may include perlite.

U.S. Pat. No. 6,319,312 herein incorporated by reference in its entirety, teaches mixing calcium sulfate, perlite and a vinyl acetate emulsion.

### SUMMARY OF THE INVENTION

In an embodiment of the invention, we provide a more efficient and economical method for manufacturing rapid setting binder compositions.

In an embodiment of the invention, we reduce the buildup on the mixer during the manufacture of rapid setting binder compositions.

In an embodiment of the invention, we provide rapid setting binder compositions with reduced buildup of binder composition or components of binder compositions on the mixer.

In an embodiment of the invention, we provide a lightweight binder composition made by a more efficient and economical method for manufacturing rapid setting binder compositions.

In an embodiment of the invention, we provide a method of making a lightweight cement board comprising a more efficient and economical method for manufacturing rapid setting binder compositions.

In an embodiment of the invention, we provide a cement board made from the rapid setting binder composition made by a more efficient and economical method for manufacturing.

In an embodiment of the invention, we provide a method of staging water demand by delayed perlite addition when making rapid setting binder compositions. In this invention, the sticky components (for example without limitation stucco, fumed silica, and/or cement), referred to as reactive powders, and lightweight aggregates of the binder compositions are first mixed with the liquids allowing for fast dispersion into a homogeneous paste and resulting in a faster wetting time of the components before the perlite is added and less buildup of material on the mixer (as compared to the prior art methods which add perlite with the reactive powders and lightweight aggregates). Following this, the non-sticky component, comprising expanded perlite, is blended into the paste. Less buildup occurs on the mixer before and after the perlite is added than in the prior art methods. This method does not substantially change the quantity of liquids used as compared to the prior art method, which mixes the expanded perlite at the same time as the reactive powders or is the final consistency of the binder composition changed from the prior art but the buildup on the mixer is substantially reduced as compared to the prior art method.

In an embodiment of the invention, we provide a method of making rapid setting binder compositions with reduced buildup on the mixer.

Benefits of the binder composition of the present invention include a rapid setting (for example, about 10 minutes to about 5 minutes after mixing with water), at room temperature (about 40-120° F., preferably 50-100° F., more preferably 40-90° F.). Setting of the composition is characterized by initial and final set times, as measured using Gilmore needles specified in the ASTM C266 test procedure, as well as high initial compressive strength. The final set time also corresponds to the time when a cement-based product e.g. a cement board, has sufficiently hardened so that it can be handled. It will be understood by those skilled in the art that curing reactions continue for extended periods after the final setting time has been reached. Rapid set is typically a final set time (i.e., the time after which cement boards can be handled) of the binder composition as measured according to the Gilmore needle test that should be at most 20 minutes, more preferably at most 10 minutes, or at most 5 minutes, typically 5 to 7 minutes, after mixing. Final set time measured by the Gilmore needle method according to ASTM C266 was the time when no mark was left on a test sample mixture when the Gilmore needle was slowly lowered to the surface of the mixture.

The rapid setting binder composition of the present invention includes a reactive powder of about 10-75 wt. % cement, about 25-75 wt. % stucco, and about 5-30 wt. % pozzolanic material, wherein the pozzolanic material preferably includes silica fume. The binder composition may also have an absence of triethanolamine.

The binder composition optionally includes 2-10 wt. % lightweight aggregates and expanded perlite, and entrained air, for example 10-50 vol. %, on a wet basis, and optional additives such as water reducing agents, chemical set-accelerators, chemical set-retarders, and crystal nucleating agents, preferably ground gypsum, more preferably, heat resistant accelerators, which are finely ground gypsum, which may be coated with sucrose or dextrose or uncoated. The binder may also optionally contain 0-35 wt. % secondary fillers, for example 10-35 wt. % secondary fillers. Typical secondary fillers include one or more expanded clay, shale aggregate, limestone, expanded plastic beads, hollow glass microspheres, cenospheres, and pumice, and exclude perlite.

Cementitious products with lightweight density are preferred. Lightweight products of this invention, for example lightweight board or other lightweight compositions, preferably have a density less than 120 pcf (pounds per cubic foot), more preferably less than 90 pcf, and most preferably less than 65 pcf. Obtaining lightweight density is assisted by employing (i) expanded perlite employing special attributes, expanded clay, shale, and/or expanded plastic beads and (ii) air entrainment.

The entrained air represents 10-50% of composite volume on a wet basis. Air-entrainment in the compositions of the invention is provided by means of suitable surfactants that form a stable and uniform structure of air voids in the finished product.

In an embodiment of the invention, we provide lightweight cement board from the binder composition of the invention.

In an embodiment of the invention, we provide binder compositions and products having a density in the range of about 30 to 120 pcf, more preferably less than 90 pcf, and most preferably less than 65 pcf. The compositions and products being set. The preferred flexural strength of boards made from this composition ranges between 400 to 2500 psi when tested per the ASTM C947 standard.

In an embodiment of the invention, we provide lightweight cement boards that on a 0.15 to 2 inches, preferably 0.20 to 1.00 inches, most preferably 0.25 to 0.75 inches, thick basis weigh preferably less than 5 pounds per sq.ft., more preferably less than 4 pounds per sq.ft., and most preferably less than 3 pounds per sq.ft., e.g., 0.5-5 pounds per sq.ft., more preferably 0.5-4 pounds per sq.ft., and most preferably 0.5-3 pounds per sq.ft.

In an embodiment of the invention, we provide cement board panels that are used as durable and bondable substrate for installation of ceramic tiles, dimensional stones, and plaster finishes.

In an embodiment of the invention, we provide cement board panels that have good water repellency and resistance to water penetration.

In an embodiment of the invention, we provide cement board products that have good moisture durability and dimensional stability to allow them to be used in wet areas in buildings.

In an embodiment of the invention, we provide lightweight cement boards that are resistant to bacteria, mold, and fungal growth.

In an embodiment of the invention, we provide lightweight cement board products that have good freeze-thaw durability.

In an embodiment of the invention, we provide cement boards that are responsible for development of good bond between the cementitious core and surface reinforcing meshes in thin cement board products during and after manufacturing.

In an embodiment of the invention, we provide lightweight binder compositions that lead to efficient processing of lightweight cement board products in commercial manufacturing environments.

In an embodiment of the invention, we provide methods for preparing lightweight binder compositions for manufacturing cement board panels and building products.

Thus, this invention relates generally to rapid setting lightweight binder compositions for construction of panels or boards and the method of making the binder compositions.

Obtaining the lightweight density is assisted by employing (i) expanded perlite employing special attributes and (ii) air entrainment.

The entrained air typically represents 5-60 volume %, more typically 30-50 volume %, on a wet basis. Air-entrainment in the compositions of the invention is provided by means of suitable surfactants that form a stable and uniform structure of air voids in the finished product.

The lightweight binder compositions of the present invention can be used to make precast concrete products such as cement boards with excellent moisture durability for use in wet and dry locations in buildings. The precast concrete products such as cement boards are made under conditions which provide a rapid setting of the binder composition so that the boards can be handled soon after the cementitious mixture is poured into a stationary or moving form or over a continuously moving belt.

Typically, the board has a thickness of about 0.15 to 2 inches, preferably 0.20 to 1.00 inches, most preferably 0.25 to 0.75 inches.

The invention may also provide a floor system comprising cement boards of the invention, which pass a minimum of first three cycles of the test per ASTM C627 for structural durability.

All percentages, ratios and proportions herein are by weight, unless otherwise specified. Also, any average molecular weights are weight average molecular weight unless specified otherwise.

As used in the present disclosure, for the paste and slurry to be “homogeneous” means the solids are distributed in the liquid of the paste or slurry at least 90% homogeneous, and preferably at least 95% homogeneous, when measured by a sample from the upper half of the mixer and a sample from the lower half of the mixer and averaged.

### BRIEF DESCRIPTION OF THE DRAWINGS

FIGS. 1a, 1b and 1c are photographs of a small scale mixer performing the prior art method of making rapid setting binder compositions at time 0, 5 seconds and 15 seconds, respectively.

FIGS. 2a and 2b are photographs of a small scale mixer performing the inventive method before the perlite is added, at time 0 and 5 seconds, respectively.

FIG. 3 is a diagram of the inventive method.

### DETAILED DESCRIPTION OF THE INVENTION

### Method

A method of making rapid setting binder compositions is provided comprising the following steps in order: providing solids comprising reactive powders and lightweight aggregate and which exclude perlite, to an inlet of a mixer, then introducing liquids to a second inlet of the mixer, wherein the second inlet is downstream of or at the same entry location to the mixer as the inlet, mixing the solids and liquids, preferably at 45-100° F., until the solids and liquids are homogeneously mixed, and then adding expanded perlite to the mixer via a third inlet, wherein the third inlet is downstream of the location in the mixture where the solids and the liquids are homogeneously mixed. Then continuing to mix the solids, the liquids and the expanded perlite until a homogeneous paste is formed. Optionally, then adding air entraining agents via a fourth inlet to the mixer, wherein the fourth inlet is downstream of the location in the mixer where the homogeneous paste is formed.

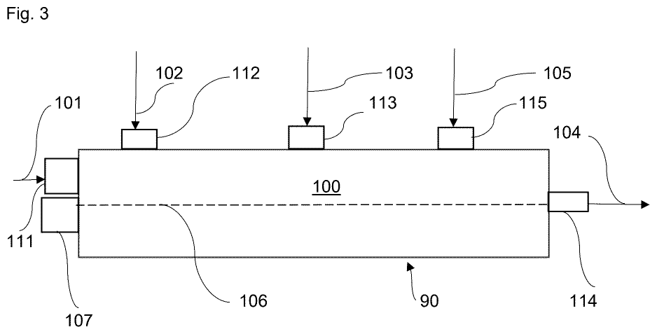

FIG. 3 is a diagram of an embodiment of the inventive method. In FIG. 3, a horizontal mixer 90 is an inline continuous mixer having a horizontal mixer vessel 100 with a horizontal longitudinal axis 106, a liquids feed 101, a solids feed 102, an expanded perlite feed 103, a slurry stream 104 and an optional air entraining agent feed 105. An impeller is located in the horizonal mixer vessel 106 and is driven by a motor 107. The solids and liquids feed system includes (a) a liquids inlet port 111 for the introducing of the liquids feed 101 and a solids inlet port 112 for the feeding of the solids feeds 102, or (b) a combined liquids and solids inlet port (such as 111 or 112) for the introducing of the liquids feed and the feeding of the solids feed. The expanded perlite feed 105 is added to the vessel 100 via the perlite inlet port 113. The slurry stream 104 exits the vessel 100 via the outlet port 114, wherein the outlet port discharges the slurry in a direction a) perpendicular to the horizontal longitudinal axis 106, or b) horizontal along the horizontal longitudinal axis, or c) parallel to the horizontal longitudinal axis. The perlite inlet port 113 is downstream of the solids and liquids feed system. The optional air entraining agent port 115 for adding the optional air entraining agent feed 105 to the vessel 100 is downstream of the expanded perlite inlet port 113.

The invention provides a method of making a rapid setting, lightweight binder composition comprising:
feeding solids to a mixer, wherein the solids comprise reactive powder, and optional lightweight aggregate and exclude expanded perlite (coated or uncoated), wherein the reactive powders comprise stucco, cement, preferably Portland cement, and pozzolanic material,
wherein the pozzolanic material comprises any finely ground silicate or aluminosilicate material that can react with calcium hydroxide and water to form calcium silicate hydrates, wherein finely ground means the median particle size D50 on a volume basis is less than 50 μm,
introducing liquids to the mixer, wherein the liquids comprise water and optional additives,
mixing the solids and the liquids, preferably at 45-100° F., to form a homogeneous paste;
adding expanded perlite to the homogeneous paste in the mixer,
mixing the paste and the expanded perlite to form a slurry, the mixer having an impeller operating at a single mixing speed during the feeding, introducing, mixing to form the paste, adding, and mixing to form the slurry; and
discharging the slurry, and
optionally adding at least one air entraining agent at 5-60 vol %, preferably 20-50 vol %, based on the binder composition.

The invention provides a method of making a board product comprising a method of making a rapid setting, lightweight binder composition comprising:
feeding solids to a mixer, wherein the solids comprise reactive powder, and optional lightweight aggregate and exclude expanded perlite (coated or uncoated), wherein the reactive powders comprise stucco, cement, preferably Portland cement, and pozzolanic material,
wherein the pozzolanic material comprises any finely ground silicate or aluminosilicate material that can react with calcium hydroxide and water to form calcium silicate hydrates, wherein finely ground means the median particle size D50 on a weight basis is less than 50 μm,
introducing liquids to the mixer, wherein the liquids comprise water and optional additives,
mixing the solids and the liquids, preferably at 45-100° F., to form a homogeneous paste;
adding expanded perlite to the homogeneous paste in the mixer,
mixing the paste and the expanded perlite to form a slurry, the mixer having an impeller operating at a single mixing speed during the feeding, introducing, mixing to form the paste, adding, and mixing to form the slurry; and
discharging the slurry, and
optionally adding at least one air entraining agent at 5-60 vol %, preferably 20-50 vol %, based on the binder composition, and
applying the binder composition in a continuous production line to form a board product.

The invention provides a method of providing a board product comprising the method of making a binder composition and comprising setting the slurry to form a product having a product density of 30 to 120 pcf.

### Manufacturing of Precast Concrete Products Such as Cement Boards

Precast concrete products such as cement boards are manufactured most efficiently in a continuous process in which the binder composition is made according to the present invention just prior to placing the mixture in a mold or over a continuous casting and forming belt.

Due to the rapid setting characteristics of the binder composition, the binder composition is usually mixed just prior to (typically 1-20 minutes prior to) the casting operation. As a consequence of the hydration of calcium sulfate hemihydrate and the associated water consumption in substantial quantities, the cement-based product becomes rigid, and ready to be cut, handled and stacked for further curing.

Thus, the binder composition of the invention is combined with a suitable amount of liquids to hydrate the reactive powder and to rapidly form gypsum or calcium sulfate dihydrate. Generally, the amount of water added will be greater than theoretically required for the hydration of the reactive powder. This increased water demand is allowed to facilitate the workability of the slurry. Typically, the weight ratio of the reactive powder to water is about 100:40-70. The amount of water depends on the needs of the individual materials present in the composition.

Gypsum or calcium sulfate dihydrate form very rapidly in the hydration process thus imparting rapid set and rigidity to the mixtures made with the binder composition of the invention. In manufacturing cement-based products such as cement boards, it is primarily the rapid hydration of calcium sulfate hemihydrate or stucco, which makes possible handling of cement boards within a few minutes after the binder composition is prepared.

Setting of the composition is characterized by initial and final set times, as measured using Gilmore needles specified in the ASTM C266 test procedure, as well as high initial compressive strength. The final set time also corresponds to the time when a cement-based product e.g. a cement board, has sufficiently hardened so that it can be handled. It will be understood by those skilled in the art that curing reactions continue for extended periods after the final setting time has been reached.

The slurry in the present invention surprisingly has a relatively low temperature, around room temperature. The slurry temperature should be at least about 40° F. (4.4° C.) and produces rapid setting times.

### Mixer

The mixer for the present method is preferably a continuous mixer, preferably a single pass horizontal continuous mixer for example as set forth in U.S. Pat. No. 11,224,990, herein incorporated by reference. The mixer is preferably a single stage mixer with a single motor driving the rotor, and each of the components is mixed at the same speed as the other components. Thus, unlike above discussed WO2023126069, the present invention has a single stage mixer with a single motor and a single mixing speed used for mixing in each component.

The mixer as shown in FIG. 3, employed in the method of making the binder composition, comprises:
a horizontal mixer vessel 100 having a horizontal longitudinal axis 106, wherein an impeller is located within the vessel; and
a solids and liquids feed system comprising:
(a) a liquids inlet port 111 for the introducing of the liquids and a solids inlet port 112 for the feeding of the solids, or
(b) a combined liquids and solids inlet port (111 or 112) for the introducing of the liquids and the feeding of the solids;
a perlite inlet port 113 for the adding of the expanded perlite;
an optional air entraining agent port 115 for adding optional air entraining agent to the slurry in the mixer.
an outlet port 114 for discharging the slurry,
wherein the liquids inlet port 111 may be upstream, downstream or at the same point relative to the horizontal longitudinal axis as the solids inlet port 112, wherein the outlet port 114 discharges the slurry in a direction a) perpendicular to the horizontal longitudinal axis, or b) horizontal along the horizontal longitudinal axis, or c) parallel to the horizontal longitudinal axis; and
wherein the perlite inlet port is downstream of the solids and liquids feed system.

In the method using the continuous mixer, the homogeneous paste and expanded perlite are mixed in a part of the mixing vessel for mixing the expanded perlite and paste and moving the paste and expanded perlite being mixed (the slurry) to the outlet port;
wherein the shaft in the part of the mixing vessel for mixing the solids and the liquids and then mixing the expanded perlite and paste and moving the expanded perlite and paste (the slurry) being mixed to the outlet port comprises at least one mixing element selected from the group consisting of (1) an auger and (2) a plurality of mixing paddles mounted on the shaft at regular intervals and different circumferential locations to extend from the shaft, wherein the at least one mixing element rotates about the shaft within the housing;
wherein the expanded perlite and paste are mixed in the mixing vessel of the continuous mixer for an average mixing residence time of about 5 to about 240 seconds, preferably 10 to 180 seconds, more preferably 10 to 120 seconds, most preferably 5 to 30 seconds while the at least mixing element applies shear force, wherein the central rotating shaft rotates at 30 to 450 RPM, more preferably 40 to 300 RPM, and most preferably 50 to 250 RPM during mixing;
then the slurry is discharged from the continuous mixer;
wherein liquids, solids, and expanded perlite are fed to the mixer simultaneously with the discharging of in the slurry from the continuous mixer.

Then, after discharging the slurry, feeding the discharged slurry to a forming assembly (preferably a “headbox”) which deposits the slurry on a moving surface of a panel production line uniformly as a layer 0.25 to 2 inches thick, preferably 0.25 to 1 inch thick, more preferably 0.4 to 0.8 inch thick, typically 0.40 to 0.75 inch thick;
leveling the slurry on a moving surface;
allowing the slurry to set on the moving surface;
cutting the set slurry into panels and removing the panels from the moving surface, wherein an additional layer of slurry is not deposited on the deposited layer of slurry.

The continuous mixer shaft is connected to a drive mechanism and a drive motor 107 to accomplish shaft rotation when the continuous mixer is in operation, wherein the shaft is externally connected to the drive mechanism and the drive motor.

The method disclosed herein is a continuous method as opposed to a batch method. In a continuous method the raw materials required to make the end product are metered and fed continuously at a rate that equals the rate (mass balance) at which the end product is being produced, that is, the raw material feed flows in the method and the end product flows out of the method simultaneously. In a batch method, the raw materials required to make the end product are first combined in large amounts to prepare a large batch of mixture for storage in appropriate vessel/s; this batch of mixture is then subsequently drawn from the storage vessel/s to produce multiple pieces of the end product. The present method may also be performed as a batch method.

The method of the present invention continuously produces a cementitious panel having at most a single layer of binder composition on a conveyor-type frame supporting a moving web. The continuous mixer is in operational relationship to the frame and configured for discharging the slurry to a first slurry feed station (preferably a headbox) which is in operational relationship to the frame and configured for depositing the layer of slurry upon the moving web. Preferably the moving surface (moving web) moves at a speed of 1 to 100 feet per minute, more preferably 5 to 50 feet per minute. This is substantially faster than the conventional cement extrusion processes utilizing viscous cementitious mixtures. Typically, the slurry is deposited at a rate of about 0.10-25 cubic feet per minute for a panel 4 to 8 feet wide. This method of producing cementitious products is also much faster than the typical extrusion manufacturing processes employed in the industry. The slurry levels and sets as it travels on the moving web. Downstream is an apparatus for cutting the set slurry into cement boards.

### Binder Compositions

TABLE 1 shows weight proportions of ingredients in the reactive powders of the present invention, e.g., cement, calcium sulfate alpha hemihydrate, and pozzolanic material, based on dry weight of 100 parts of the reactive powder.

TABLE 1 describes mixtures used to form the binder compositions of the present invention.

TABLE 1
Reactive Powders (wt. %, dry basis)

| Ingredient (weight % of | | | More | |
|---|---|---|---|---|
| reactive powder) | Broad | Preferably | preferably | Typically |
| Cement | 10-75 | 15-60 | 20-50 | 25 |
| stucco | 25-75 | 35-70 | 50-70 | 65 |
| Pozzolanic material | 5-30 | 7.5-25 | 8-20 | 10 |

Reactive powders comprise cement, stucco, and pozzolanic materials as set forth in Table 1 above.

### Stucco

Calcium sulfate hemihydrate or stucco is made from gypsum ore, a naturally occurring mineral, (calcium sulfate dihydrate CaSO₄·2H₂O). Unless otherwise indicated, “gypsum” will refer to the dihydrate form of calcium sulfate. After being mined, the raw gypsum is thermally processed to form a settable calcium sulfate, which may be anhydrous, but more typically is the hemihydrate, CaSO₄·½H₂O. For the familiar end uses, the settable calcium sulfate reacts with water to solidify by forming the dihydrate (gypsum). The hemihydrate has two recognized morphologies, termed alpha hemihydrate and beta hemihydrate. These are selected for various applications based on their physical properties and cost. Both forms react with water to form the dihydrate of calcium sulfate. Upon hydration, alpha hemihydrate is characterized by giving rise to rectangular-sided crystals of gypsum, while beta hemihydrate is characterized by hydrating to produce needle-shaped crystals of gypsum, typically with large aspect ratio. In the present invention either or both of the alpha or beta forms may be used depending on the mechanical performance desired. The beta hemihydrate forms less dense microstructures and is preferred for low density products. The alpha hemihydrate forms more dense microstructures having higher strength and density than those formed by the beta hemihydrate. Thus, the alpha hemihydrate could be substituted for beta hemihydrate to increase strength and density, or they could be combined to adjust the properties.

### Pozzolanic Material

Pozzolanic materials, a component of the reactive powders, are siliceous or siliceous and aluminous materials which in themselves possess little or no cementitious value, but will, in finely divided form and in the presence of moisture, chemically react with calcium hydroxide (produced by the reaction of cement with water) at ordinary temperatures to form compounds possessing cementitious properties. Typically, the pozzolanic material comprises any finely ground silicate or aluminosilicate material that can react with calcium hydroxide and water to form calcium silicate hydrates. Various natural and man-made materials have been referred to as pozzolanic materials possessing pozzolanic properties. Some examples of pozzolanic materials include pumice, diatomaceous earth, silica fume, tuff, trass, rice husk, metakaolin, ground granulated blast furnace slag, fly ash and any combination thereof. All of these additional pozzolanic materials can be used either singly or in combined form as part of the reactive powder of the invention.

Silica fume is finely divided amorphous silica which is a by-product of silicon metal and ferro-silicon alloy manufacture. Silica fume, also known as microsilica, (CAS number 69012-64-2, EINECS number 273-761-1) is an amorphous (non-crystalline) polymorph of silicon dioxide, silica. It is typically an ultrafine powder and consists of smooth glassy spherical particles of amorphous SiO₂. Typically, silica fume is at least 80 wt. % amorphous. Page 8 the “Silica Fume User's Manual”, FHWA-IF 05 016, Silica Fume Association and US Dept. of Transportation/Federal Highway Administration (April 2005) provides a definition of “amorphous”.

Silica fume is sometimes confused with fumed silica (also known as pyrogenic silica, CAS number 112945-52-5). However, the production process, particle characteristics and fields of application of fumed silica are all different from those of silica fume.

Also, silica flours and silica fume are different materials with different characteristics. Silica flours are small angular, irregular particles of crystalline silica sand. Silica flour is a very finely divided, highly purified form of crystalline silica that consists of particles of up to 100 μm in diameter. Nano size particles (10-100 nm) may be present in some preparations. Silica flours are not pozzolanic material. The “Silica Fume User's Manual”, FHWA-IF 05 016, Silica Fume Association and US Dept. of Transportation/Federal Highway Administration (April 2005) also discloses silica flour is not a pozzolan. At the bottom of Page 3 is the description for silica flour, “Silica flour and silica dust-caution: these materials are a crystalline form of silica that will not perform like silica fume in concrete”.

Fly ash is a pozzolanic material which may be useful preferably with silica fume. Fly ashes containing low calcium oxide content (such as Class F fly ashes of ASTM C618-22 standard) are preferred as explained below.

Fly ash is a fine powder byproduct formed from the combustion of coal. Electric power plant utility boilers burning pulverized coal produce most commercially available fly ashes. These fly ashes consist mainly of glassy spherical particles as well as residues of hematite and magnetite, char, and some crystalline phases formed during cooling. The structure, composition and properties of fly ash particles depend upon the structure and composition of the coal and the combustion processes by which fly ash is formed. ASTM C618 standard recognizes two major classes of fly ashes-Class C and Class F. These two classes of fly ashes are derived from different kinds of coals that are a result of differences in the coal formation processes occurring over geological time periods. Class F fly ashes are normally produced from burning anthracite or bituminous coal, whereas Class C fly ashes are normally produced from lignite or sub-bituminous coal.

The ASTM C618-22 standard differentiates Class F and Class C fly ashes primarily according to their pozzolanic properties. Accordingly, in the ASTM C618-22 standard, the major specification difference between the Class F fly ash and Class C fly ash is the amount of lime or calcium oxide (CaO) in the composition. Class F fly ashes have a maximum lime content of less than 18 wt. %, whereas Class C fly ashes have a lime content of greater than 18 wt. %. Class F fly ashes tend to be more pozzolanic than the Class C fly ashes.

The fly ash comprises Class F fly ash, Class C fly ash, or mixtures thereof, with up to 30 wt. % calcium oxide, which is incorporated in the glass structure on the fly ash particles. Preferably, the fly ash is a Class F fly ash comprising preferably up to 24 wt. %, up to 18 wt. %, up to 16 wt. %, up to 10 wt. %, up to 6 wt. %, or up to 1 wt. %, most preferably 1-30 wt. %, 1 to 18 wt. %, 1 to 16 wt. %, 1 to 10 wt. %, or 1 to 6 wt. % calcium oxide. If desired, the fly ash is a Class F fly ash comprising 4-18 wt. %, 4-16 wt. %, 4 to 10 wt. %, or 4 to 6 wt. % calcium oxide.

### Cement

The cement comprises hydraulic cement, including Portland cement, Portland limestone blended cement, white cement, slag cements such as blast-furnace slag cement, pozzolan blended cements, expansive cements, sulfo-aluminate cements, oil-well cements, preferably Portland cement, more preferably type III Portland cement. ASTM C 150 standard specification for Portland cement defines Portland cement as a hydraulic cement produced by pulverizing clinker consisting essentially of hydraulic calcium silicates, usually containing one or more of the forms of calcium sulfate as an inter-ground addition. More generally, other hydraulic cements may be substituted for Portland cement, for example calcium sulfo-aluminate based cements. To manufacture Portland cement, an intimate mixture of limestone and clay is ignited in a kiln to form Portland cement clinker. The following four main phases of Portland cement are present in the clinker-tricalcium silicate (3CaO·SiO₂, also referred to as CsS), dicalcium silicate (2CaO·SiO₂, called C₂S), tricalcium aluminate (3CaO·Al₂O₃ or C₃A), and tetracalcium aluminoferrite (4CaO·Al₂O₃·Fe₂O₃ or C₄AF). The resulting clinker containing the above compounds is inter-ground with calcium sulfates to desired fineness to produce the Portland cement.

The other compounds present in minor amounts in Portland cement include double salts of alkaline sulfates, calcium oxide, and magnesium oxide. Of the various recognized classes of Portland cement, ASTM Type Ill Portland cement is most preferred in the reactive powder of the binder compositions of the invention. This is due to its relatively faster reactivity and high early strength development. The second most preferred is ASTM Type IL (HE) Portland blended limestone cement (as defined in ASTM C595) that has faster reactivity and high early strength development as well.

High alumina cement is also commonly referred to as aluminous cement or calcium aluminate cement. As the name implies, high alumina cements have a high alumina content, about 36-42 wt. % is typical. Higher purity high alumina cements are also commercially available in which the alumina content can range as high as 80 wt. %. These higher purity high alumina cements tend to be very expensive relative to other cements. High alumina cement and high calcium sulfo-aluminate cement may be included but is not preferable due to its expense.

### Lightweight Aggregates

Lightweight aggregates may optionally be present in the binder. It is desirable to produce lightweight products without unduly comprising the desired mechanical properties of the product. This objective is achieved by adding lightweight aggregates. Examples of useful lightweight aggregates include blast furnace slag, volcanic tuff, pumice, expanded forms of clay, shale, hollow ceramic spheres, hollow plastic spheres, expanded plastic beads, vermiculite, slate, scoria, expanded slag, cinders, glass microspheres, synthetic ceramic microspheres, hollow ceramic microspheres, lightweight polystyrene beads and the like. For producing cement boards, expanded clay and shale aggregates are particularly useful. Expanded plastic beads and hollow plastic spheres when used in the composition are employed in very small quantities on weight basis owing to their extremely low bulk density.

Lightweight aggregates typically have a specific gravity of less than about 1.75, preferably less than about 1, more preferably less than about 0.75, and still more preferably less than about 0.5. In some other preferred embodiments of the invention the specific gravity of lightweight aggregates is less than about 0.35, more preferably less than about 0.25 and most preferably less than about 0.1. In contrast, inorganic mineral filler preferably has a specific gravity above about 2.0.

Pumice used as lightweight aggregate is a hydrated aggregate (filler) and not cement. In contrast, pumice used as pozzolanic mineral additive (describe in the above-listed section entitled “Mineral Additives”) is a non-hydrated form and falls within the ASTM C618-97 definition of pozzolanic materials as “siliceous or siliceous and aluminous materials which in themselves possess little or no cementitious value, but will, in finely divided form and in the presence of moisture, chemically react with calcium hydroxide at ordinary temperatures to form compounds possessing cementitious properties.”

Depending on the choice of lightweight aggregate selected, the weight ratio of the lightweight aggregate to the reactive powders may be about 0 to 200/100, preferably about 2/100 to 125/100. For example, for making lightweight cement boards, the weight ratio of the lightweight aggregates to the reactive powder blend may be about 2/100 to 125/100.

Moisture content of a lightweight aggregates adversely affects the setting time of the binders. Thus, aggregates having low water content are preferred in the present invention.

### Liquids

Liquids comprise water and optionally dispersants, salts, retardants, surfactants, and other additives. The reactive powder and lightweight aggregates of the present invention are mixed with liquids to form a slurry. The liquids:reactive powder weight ratio is 0.40-0.70, preferably 0.45, 0.50, 0.55, 0.60, 0.62, or 0.70.

### Expanded Perlite

The expanded perlite serves an important purpose in the invention, which would otherwise be heavier than is desirable for building purposes.

Perlite is a large volume of the dry powders (including reactive powders, lightweight aggregates and perlite) (about 20-60 vol. %, preferably 30-50 vol. %) in rapid setting binder compositions due to its low specific gravity. By delaying the addition of the perlite until after the other powders (the solids) wet out, the stucco does not become overly sticky. Without being limited to mechanism, it is believed that this is because the perlite in the prior art processes attracts much of the liquids, preventing the stucco from sufficiently wetting out quickly and the stucco becomes sticky.

The binder composition may comprise lightweight expanded perlite filler, either coated or uncoated, preferably coated. The expanded perlite filler may be present at about 0.01-0.15 perlite:reactive powder weight ratio.

The expanded perlite has a median particle diameter typically between 20-500 microns or 20 to 250 microns, preferably between 20-150 microns, more preferably between 20-90 microns, and most preferably between 20-60 microns. Also, the expanded perlite has an effective particle density (specific gravity) preferably less than 0.50 g/cc, more preferably less than 0.40 g/cc and most preferably less than 0.30 g/cc.

To assist in achieving these low densities the panels are provided with lightweight coated expanded perlite filler particles. The expanded perlite filler is about 2-10 weight %, about 7.5-40 volume % of the binder composition slurry (on a wet basis).

The expanded perlite of this invention is not completely hollow but has a honeycomb internal microstructure as seen in U.S. Pat. No. 8,038,790. The honeycomb microstructure is essentially created by thin walls that run randomly within the hollow space of the perlite particle. The multiple walls present in the perlite particle intersect each other randomly and thereby compartmentalize the overall particle volume into small sections. This honeycomb microstructure provides several benefits to the perlite and the cementitious compositions of the invention. Important benefits provided by the honeycomb microstructure include:

1. Reduced particle water absorption: As the particle internally is subdivided into small sections due to its honeycomb construction, the migration of water from one section to another within the particle is interrupted by the internal walls. As a consequence, the absolute water absorption of the perlite particle is reduced very significantly. Perlite particles with lower water absorption are beneficial in the present invention, since they help to reduce the water demand of the cementitious slurry and enhance the mechanical and durability performance of the finished product.

2. Increased particle stiffness and strength: The honeycomb walls within the particle help to substantially increase the stiffness and strength of the particle. As a result, the perlite particles are less prone to damage during manufacture transportation and conveying at various stages of their life cycle. Moreover, the relatively high particle stiffness and strength are also extremely beneficial in various mixing operations for preparing cementitious slurries where the particles are subjected to extensive shearing and crushing actions. The high particle stiffness and strength help to maintain the particle integrity under aggressive mixing conditions.

As a result, the perlite particles are able to maintain their lightweight property and low water absorption when used in manufacture of cement panel products. It should be noted that with crushing and breakage of perlite particles, the particle density increases significantly thereby diminishing the lightweight and low water absorption.

The expanded perlite may be 2-10 weight %, 7.5-40 volume % of the binder composition on a wet basis. The expanded perlite is composed of particles having a Dp50 by number of particles mean particle diameter typically between 20-500 microns or 20 to 250 microns, preferably between 20-150 microns, more preferably between 20-125 microns, even more preferably between 20-100 microns, and most preferably between 20-75 microns, an effective particle density preferably less than 0.50 g/cc, more preferably less than 0.40 g/cc, for example 0.10-0.40 g/cc, and most preferably less than 0.30 g/cc.

The expanded perlite may be coated with silicone, silane or siloxane coatings such as dimethyl silicone, dimethydichlorosilane or polydimethylsiloxane. If desired, coatings of titanates or zirconates may be employed. Typically, the coatings are provided in an amount of 0.01 to 3%, more typically 0.01 to 2%, by weight of the uncoated weight of the perlite particle. The coatings on the perlite are typically cross-linked hydrophobic film forming compounds. Typical silicones are organo-functional silanes having the general formula R—SiX₃ wherein R is selected from the group consisting of alkoxy and acetoxy such as acrylate, methacrylate, glycidoxy, epoxy propoxy, epoxy cyclohexyl and vinyl and X is selected from the group consisting of halogen, alkoxy and acetoxy.

Furthermore, the coated expanded perlite filler particle size allows formation of an effective-water-tight closed cell particle structure with the applying of the chemical coating. The use of the selected coated expanded perlite filler is important to allowing preparation of workable and processable slurries at low water usage rates. Lower amounts of water in the composition results in a product having superior mechanical properties and physical characteristics. The most preferred chemical coating compounds for making perlite particles water-tight and water repellant are alkyl alkoxy silanes and silicone emulsions comprising mixtures of silanes and/or siloxanes. Octyltriethoxy silane represents the most preferred alkyl alkoxy silane to coat perlite for using with the binder of this invention.

One of the most preferred commercially available chemically coated perlite fillers is SIL-CELL 35-23 available from Silbrico Corporation. SIL-CELL 35-23 perlite particles are chemically coated with alky alkoxy silane compound. Other preferred chemically coated perlite fillers are SIL-CELL 35-34, SIL-CELL 32-23, SIL-CELL 42-23, SIL-CELL 43-23, SIL-CELL 50-23, SIL-CELL 32-34, SIL-CELL 35-34, SIL-CELL 43-34, SIL-CELL 43-34, and SIL-CELL 50-34, all available from Silbrico Corporation. SIL-CELL 35-34, SIL-CELL 32-23, SIL-CELL 42-23, SIL-CELL 43-23, SIL-CELL 50-23 particles are coated with a silane coating having a monomer molecular structure, whereas, the SIL-CELL 32-34, SIL-CELL 35-34, SIL-CELL 43-34, SIL-CELL 43-34, and SIL-CELL 50-34 are coated with silicone coating having a polymer molecular structure. DICAPERL 210 and DICAPERL 220 are yet another two commercial coated perlite filler products produced by Grefco Minerals Inc. that are preferred in this invention. DICAPERL 210 perlite, with alkyl alkoxy silane compound is particularly preferred in the binders of the invention. DICAPERL 220 perlite, coated with silicone compound is also useful in the binders of this invention. Another example of a preferred perlite is MICROSIL 200S from Termolita.

Another very useful property of the perlite of the invention is that they display pozzolanic properties because of their small particle size and silica-based chemical nature. Owing to their pozzolanic behavior, the selected perlite of the invention improves chemical durability of the composites while developing improved interfaces and enhanced bonding in the binding compositions.

Yet another important benefit results from the small size of the perlite particles of this invention. This improvement pertains to the manufacturability and performance characteristics of mesh reinforced cement board products produced using the perlite of the invention. Selected perlite of the invention enhances the overall amount of very fine particles (less than 75 microns Dp50 by number of particles) present in the composition. Presence of high content of fine particles in the composition is extremely useful in rapid processing of mesh reinforced cement board as it helps to improve the bond between the binding compositions and reinforcing mesh. Improved bond between binding compositions and reinforcing mesh leads to reduced occurrences of mesh delamination, faster cement board processing speeds, and improved production recoveries.

### Plasticizer

Plasticizers, also known as superplasticizers, may be included in the binder compositions of the invention and added in the dry form or in the form of a solution. Plasticizers help to enhance workability and reduce the water demand of the aqueous mixture. Examples of plasticizers include polycarboxylate ethers (“PCE”), polyacrylates, polycarboxylates, lignosulfonates, melamine sulfonates, and the like. Naphthalene sulfonates may be excluded from the binders of the present invention.

The plasticizer is present in an amount equal to about 0.05-3 wt. % of the reactive powder, preferably about 2 wt. % or less, preferably about 0.1 to 1.0 wt. %, more preferably about 0.05 to 0.80 wt. %, even more preferably 0.10 to 0.60%, and most preferably about 0.15 to 0.40 wt. %.

The plasticizer may include polycarboxylate ether (“PCE”) plasticizers, for example BASF's LVR Flow 16. U.S. Pat. No. 7,767,019 to Liu et al., incorporated by reference, discloses embodiments of branched polycarboxylates suitable for use as dispersants for the present gypsum slurries. U.S. Pat. No. 10,442,732 to Vilinska et al., incorporated by reference, discloses examples of linear polycarboxylate dispersants. Plasticizers used in this invention typically do not include naphthalene sulfonate based plasticizers. The plasticizer is added to enhance workability and reduce the water demand of the binder.

### Other Chemical Additives and Ingredients

TABLE 2 lists typical additive ranges in accordance with this invention.

TABLE 2
Additive ranges (in an amount equal
to weight % of reactive powder)

| | Preferred | More preferred | Most preferred |
|---|---|---|---|
| Nucleating Agent (HRA) | 0-1.5 | 0.2-1.2 | 0.3-1.1 |
| Plasticizer (preferably PCE) | 0.1-1 | 0.15-0.75 | 0.2-0.5 |
| Aluminum sulfate (“Alum”) | 0-1 | 0-0.5 | 0-0.1 |
| Retarder | 0-1 | 0-0.5 | 0-0.1 |

TABLE 3 lists formulation ranges in accordance with this invention.

TABLE 3
Formulation ranges

| | |
|---|---|
| Liquids/ reactive powder weight ratio | 0.40-0.80 |
| Lightweight aggregates/ reactive powder weight ratio | 0-1.75 |
| Expanded Perlite/ reactive powder weight ratio | 0.02-0.15 |
| Portland cement (wt. % of reactive powder) | 20-40 |
| Stucco weight (wt. % of reactive powder) | 30-75 |
| Pozzolanic materials weight (wt. % of reactive powder) | 5-30 |

The nucleating agent is a component of the reactive powders. The plasticizer, aluminum sulfate and retarder are components of the liquids.

Aluminum sulfate may be present in the binder composition in an amount equal to 0-1 wt. % of the reactive powder, preferably 0-0.5 wt. % and most preferably 0.01-0.10 wt. %.

Mineral-based nucleating agents (referred to also as “nucleating agents”) such as finely ground gypsum (with or without chemical treatment) may be present in the binder composition of the invention. Finely ground gypsum nucleating agents, also termed here as heat-resistant accelerators (HRAs), may be present in the binder composition and comprise for example a gypsum powder finely interground with dextrose. In the binder composition of this invention, the heat-resistant accelerator (HRA) may be present in an amount equal to 0.1-1.5 wt. %, preferably 0.3-1.2 wt. %, most preferably 0.5-1.1 wt. % of the reactive powder.

Examples of heat-resistant accelerator (HRA) include finely ground gypsum coated with dextrose and/or sucrose or simply uncoated ground gypsum. An example is further described in U.S. Pat. No. 2,078,199, herein incorporated by reference.

Mineral-based nucleating agents such as finely ground gypsum are crucial to some embodiments of the present invention as they allow rapid setting action and strength development of cementitious mixture to enable rapid production of building products on a production line.

### Retarders

Use of set retarders as a component in the compositions of the invention is particularly helpful in situations where mixture utilizes lower water amount, or where longer mixing times are involved, or in scenarios where the initial slurry temperature used to form the cement-based products is particularly high, typically greater than 100° F. (38° C.). In these conditions, set retarders such as sodium citrate, citric acid, gluconic acid, or DTPA (diethylenetriamine pentaacetate) promote synergistic physical interaction and chemical reaction between different reactive components in the compositions resulting in favorable slurry workability and superior slurry temperature rise response and rapid setting behavior. Without the addition of retarders, stiffening of the reactive powder blend of the invention may occur very rapidly, soon after water is added to the mixture. Rapid stiffening of the mixture is undesirable because it contributes to poor workability and material consolidation, inferior product manufacturability, and lower product strength.

The primary function of a retarder in the composition is to keep the slurry mixture from stiffening too rapidly thereby promoting synergistic physical interaction and chemical reaction between the different reactive components. Other secondary benefits derived from the addition of retarder in the composition include reduction in the amount of plasticizer and/or water required to achieve a slurry mixture of workable consistency. All of the aforementioned benefits are achieved due to suppression of false setting. Examples of some useful set retarders include sodium citrate, citric acid, potassium tartrate, sodium tartrate, and the like. In the compositions of the invention, sodium citrate is the preferred set retarder. Furthermore, since set retarders prevent the slurry mixture from stiffening too rapidly, their addition plays an important role and is instrumental with respect to product manufacturability in commercial production environments.

Retarders may be present in the binder composition and comprise sodium citrate, citric acid, potassium tartrate, sodium tartrate or mixtures thereof. The retarders may be present in an amount equal to 0.01-1.5 wt. % of the reactive powder, preferably less than 1.0 wt. %, and most preferably less than 0.50 wt. %.

### Alkanolamines

Alkanolamines are amino alcohols that are strongly alkaline and cation active. Examples include triethanolamine [N(CH₂—CH₂OH)₃], monoethanolamine [NH₂(CH₂—CH₂OH)], diethanolamine [NH(CH₂—CH₂OH)₂]. In certain embodiments of the invention, the binder composition excludes alkanolamines. In certain embodiments, the binder excludes triethanolamine (“TEA”).

Other additives including shrinkage control agents, slurry viscosity modifying agents (thickeners), coloring agents and internal curing agents, may be included as desired depending upon the processability and application of the binder composition of the invention.

### Air-Entraining Agents

When it is desired to produce the present lightweight products such as lightweight cement boards, air-entraining agents may be added in the composition to lighten the product. Air-entrainment agents are generally suitable surfactants that form a stable and uniform structure of air voids in the finished product. Accordingly, the binder composition contains a suitable air entraining agent in such amounts to produce the desired degree of air entrainment.

Typically air entraining agents are surfactants, provided in an amount from about 0.0015 to 0.03 wt. %, based upon the total slurry weight. More preferably, the weight of these surfactants ranges between 0.002 to 0.02 wt. %, based upon the total slurry weight. For example, sodium alkyl ether sulfate, ammonium alkyl ether sulfate, sodium alpha olefin sulfonate (AOS), sodium deceth sulfate, ammonium deceth sulfate, sodium laureth sulfate, or sodium dodecylbenzene sulfonate are suitable air entraining surfactants that can be used in the compositions of the invention.

In the compositions of the invention, the air entraining agent is preferably externally produced foam used to reduce binder composition and product density. The foam is prepared using suitable surfactants together with water and air in proper proportions combined in foam generation equipment. The foam so produced is then introduced directly into the wet mixture during the mixing operation after the expanded perlite has been added and mixed to a homogeneous mixture.

Entrained air may be 5-60 vol. % of the binder composition, preferably 20-50 vol. %, most preferably 30-50 vol. %.

### Phosphates

If desired, ammonium or metal phosphates may optionally be used in the present invention. Such metal phosphates may be one or more of sodium trimetaphosphate (STMP), potassium tripolyphosphate (KTPP) and sodium tripolyphosphate (STPP). These phosphates help to strengthen the composition microstructure and increase the strength to density ratio of the final manufactured product.

Ammonium or metal phosphate is in the composition in an amount equal to 0 to 1.5 wt. %, or 0.15 to 1.5 wt. %, or about 0.3 to 1.0 wt. %, or about 0.5 to 0.75 wt. % of the reactive powder. Thus, for example, for 100 pounds of reactive powder, there may be about 0 to 1.5 pounds of the ammonium or metal phosphate.

### Inorganic Secondary Set Accelerators

In combination with the above-discussed alkanolamines and optional metal phosphates, other inorganic set accelerators may be added as inorganic secondary set accelerators in the binder composition of the invention.

Addition of these inorganic secondary set accelerators is expected to impart only a small reduction in setting time in comparison to the reduction achieved due to the addition of the combination of alkanolamines and optional metal phosphates. Examples of such inorganic secondary set accelerators include a sodium carbonate, potassium carbonate, potassium sulfate, calcium nitrate, calcium nitrite, calcium formate, calcium acetate, calcium chloride, lithium carbonate, lithium nitrate, lithium nitrite, aluminum sulfate and the like. The use of calcium chloride should be avoided when corrosion of cement board fasteners is of concern.

The weight ratio of the secondary inorganic set accelerator to the reactive powder typically will be less than 2 wt. %, preferably about 0.0 to 1 wt. %. In other words, for 100 pounds of reactive powder there is typically less than 2 pounds, preferably about 0.0 to 1 pounds, of secondary inorganic set accelerator. These secondary set accelerators can be used alone or in combination.

It will be understood by those skilled in the art that other materials may be included in the composition depending on its intended use and application.

### Examples

Example of mixing procedure:

A binder composition is set forth in TABLE 4. An air entraining agent is not considered in this example.

TABLE 4

| Component | Weight (grams) | |
|---|---|---|
| Reactive powders (65 g stucco, | 100 | g |
| 25 g cement, 10 g fly ash) | | |
| Lightweight aggregate | 50 | g |
| Expanded perlite | 9 | g |
| Liquids (including suitable accelerators, | 50 | g |

retarders and dispersants/plasticizers)

For demonstration purposes, scenarios 1 and 2 are performed in a batch mixer such that photographs at the appropriate time may be taken to display the buildup on the mixer.
Scenario 1 (prior art): The reactive powders, lightweight aggregate and expanded perlite are mixed together first and then mixed with the liquids.

$$Volume of solids ( reactive powders , lightweight aggregate and expanded perlite ) = weight ( g ) / density ( g / ml ) = 65 / 2.6 + 25 / 3.15 + 10 / 2.6 + 50 / 1.7 + 9 / 0.25 = 102.2 ml of solids$$

$$Volume of liquids = 50 ml$$

$$Volumetric liquids to solids ratio while mixing = 50 / 102.2 = 0.49$$

Scenario 2 (inventive): Staged mixing (delayed perlite addition)
Step 1: Dispersion of reactive powder and light weight aggregate

Reactive powder and lightweight aggregate are mixed and then mixed with the liquids.

$$Volume of solids ( excluding perlite ) = weight ( g ) / density ( g / ml ) = 65 / 2.6 + 25 / 3.15 + 10 / 2.6 + 50 / 1.7 = 66.2 ml of solids excluding perlite$$

$$Volume of liquids = 50 ml$$

$$Volumetric liquids to solids ratio while mixing in step 1 = 50 / 66.2 = 0.76$$

Step 2: Addition of expanded perlite

Perlite is added to the mixture.

Final volumetric liquids to solids ratio=0.49.

In scenario 1 and 2, the final volumetric liquids to solids ratio is the same. As such, the water demand and consistency of the mixture does not change between the prior art and inventive methods.

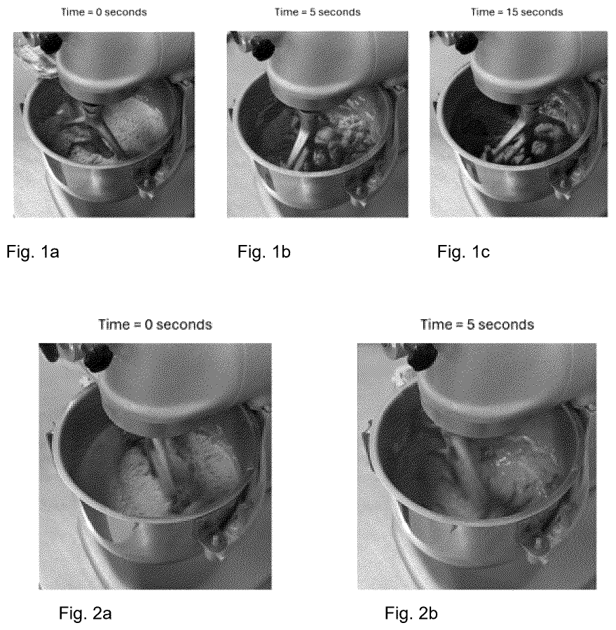

However, in scenario 2, in step 1, the volumetric liquids to solids ratio is significantly higher (0.76 vs 0.49)—55% more temporarily (until perlite is added). Without being limited to mechanism, this temporarily higher liquids to solids ratio allows for faster dispersion of the reactive powders and light weight aggregate in the liquids, resulting in less stickiness and less mixer build up. In step 2, once perlite is added, the liquids to solids volumetric ratio reaches its final value of 0.49 (same as scenario 1). The fluidity of mixtures in scenario 1 and 2 will be the same at the end. The total wetting time in scenarios 1 and 2 is the same. However, the wetting time of the reactive powders and lightweight aggregate in the liquids in scenario 2 is faster. Wetting time, or time for “wetting out” (meaning time to reach homogeneous mixtures) as shown in FIGS. 1a, 1b and 1c are photographs of a small scale mixer performing the prior art method of making rapid setting binder compositions at time 0, 5 seconds and 15 seconds, respectively. FIGS. 2a and 2b are photographs of a small scale mixer performing the inventive method before the perlite is added, at time 0 and 5 seconds, respectively. FIGS. 1a, 1b and 1c and FIGS. 2a and 2b are summarized in TABLE 5.

TABLE 5

| | Scenario 1 | Scenario 2 |
|---|---|---|
| Component | wetting time | wetting time |
| Reactive powders + | Not applicable | ~5 seconds |
| lightweight aggregate | | (LESS STICKING |
| | | AND BUILDUP) |
| Reactive powders + | ~15 seconds | ~15 seconds |
| lightweight aggregate + | (CAUSES STICKING | |
| expanded perlite | AND BUILDUP) | |

As seen in FIGS. 1a, 1b and 1c, in Scenario 1 (prior art), the reactive powders (stucco, cement, fly ash) and the fillers (expanded perlite and light weight aggregate) are added together in the mixer followed by the liquids. As such, the total mixture takes a long time to wet out (~15 seconds). When the reactive powders are wetting out, they are sticky (especially the stucco). This causes buildup in the mixer.

In Scenario 2 (FIGS. 2a and 2b), the reactive powders and light weight aggregate are added to the mixer followed by the liquids. Mixing without the expanded perlite wets out the reactive powders significantly faster (~5 seconds). The photo in FIG. 2b is taken at this location (without the perlite addition). Since the reactive powders wet out faster, the composition does not build up on the mixer as quickly as in the prior art method without delaying the perlite addition. After the reactive powders wet out, expanded perlite is added. The expanded perlite will likely take another 10 seconds to wet out (bringing the total to 15—same as first video). However, perlite is not sticky when wetting out (unlike stucco), avoiding the buildup problem.

### CLAUSES OF THE INVENTION

The following clauses describe various aspects of the invention.

Clause 1. A method of making a binder composition comprising:
feeding solids to a mixer, wherein the solids comprise reactive powder, and exclude expanded perlite (coated or uncoated), wherein the reactive powders comprise stucco, cement, preferably Portland cement, and pozzolanic material,
introducing liquids to the mixer, wherein the liquids comprise water and optional additives,
mixing the solids and the liquids, preferably at 45-100° F., to form a homogeneous paste;
adding expanded perlite to the homogeneous paste in the mixer,
mixing the paste and the expanded perlite to form a slurry, the mixer having an
impeller operating at a single mixing speed during the feeding, introducing,
mixing to form the paste, adding, and mixing to form the slurry; and
discharging the slurry.

Clause 2. The method of clause 1, wherein the mixer is a horizontal continuous mixer having:
a horizontal mixer vessel having a horizontal longitudinal axis, wherein the impeller is located within the vessel; and
a solids and liquids feed system comprising:
(a) a liquids inlet port for the introducing of the liquids and a solids inlet port for the feeding of the solids, or
(b) a combined liquids and solids inlet port for the introducing of the liquids and the feeding of the solids;
a perlite inlet port for the adding of the expanded perlite;
an outlet port for discharging the slurry,
wherein the outlet port discharges the slurry in a direction
perpendicular to the horizontal longitudinal axis, or
horizontal along the horizontal longitudinal axis, or
parallel to the horizontal longitudinal axis;
wherein the perlite inlet port is downstream of the solids and liquids feed system.

Clause 3. The method of clause 1, wherein the liquids inlet port is upstream or downstream of the solids inlet port.

Clause 4. The method of clause 1, wherein the liquids inlet port and the solids inlet port are at the same point relative to the horizontal longitudinal axis.

Clause 5. The method of clause 2, wherein the mixer further comprises an air entraining agent inlet port for adding to the slurry in the mixer an air entraining agent.

Clause 6. The method of any of clauses 1-5, further comprising adding an air entraining agent at 5-60 vol %, preferably 40-55 vol %, based on the binder composition to the slurry.

Clause 7. The method of any of clauses 1-6, wherein the pozzolanic material comprises finely ground silicate or aluminosilicate material reactive with calcium hydroxide and water to form calcium silicate hydrates.

Clause 8. The method of any of clauses 1-7, wherein the solids further comprise lightweight aggregate.

Clause 9. The method of any of clauses 1-8, wherein the reactive powder comprises about 10-40 wt. % cement, about 30-75 wt. % stucco, and about 5-30 wt. % pozzolanic material.

Clause 10. The method of any of clauses 8 and 9, wherein the lightweight aggregate:reactive powder weight ratio is 0.01-1.75:1.00.

Clause 11. The method of any of clauses 1-10, wherein the pozzolanic material comprises one or more of the group consisting of fly ash, natural pozzolan, ground granulated blast furnace slag, calcined clays, and silica fume.

Clause 12. The method of any of clauses 1-11, wherein the optional additives comprise one or more of the group consisting of accelerators, retarders, and dispersants.

Clause 13. The method of any of clauses 1-12, wherein the optional additives are Accelerators (0-1.5), retarders (0-1), and dispersants/plasticizers (0.1-1), as a percentage weight of the reactive powders.

Clause 14. The method of any of clauses 1-13, wherein the mixing step has a reactive powder:liquids weight ratio of 100:40-80.

Clause 15. The method of any of clauses 1-14, wherein the mixing temperature is 50-90° F.

Clause 16. The method of any of clauses 1-15, wherein the expanded perlite:reactive powder weight ratio is 0.05-0.15:1.00.

Clause 17. The method of any of clauses 1-16, wherein the expanded perlite is coated.

Clause 18. The method of any of clauses 1-16, wherein the expanded perlite is uncoated.

Clause 19. The method of any of clauses 6-18, wherein the air entraining agent is 5-60 vol. %, preferably 20-50 vol. %.

Clause 20. A binder composition made by the method of any of clauses 1-19.

Clause 21. A method of providing a board product comprising the method of any of clauses 1-19 and further comprising applying the binder composition in a continuous production line to form a board product.

Clause 22. A method of providing a board product comprising the method of any of clauses 1-19 and further comprising setting the slurry to form a product having a product density of 30 to 120 pcf.

Clause 23. A cement board made from the method of any of clauses 21 and 22.

Although the preferred embodiments for implementing the present invention are described, it will be understood by those skilled in the art to which this disclosure is directed that modifications and additions may be made to the invention without departing from its spirit and scope.

1. A method of making a binder composition comprising:
feeding solids to a mixer, wherein the solids comprise reactive powder, and exclude expanded perlite (coated or uncoated), wherein the reactive powders comprise stucco, cement, and pozzolanic material,
introducing liquids to the mixer, wherein the liquids comprise water and optional additives,
mixing the solids and the liquids to form a homogeneous paste;
adding expanded perlite to the homogeneous paste in the mixer,
mixing the paste and the expanded perlite to form a slurry, the mixer having an impeller operating at a single mixing speed during the feeding, introducing, mixing to form the paste, adding, and mixing to form the slurry; and
discharging the slurry.

2. The method of claim 1, wherein the mixer is a horizontal continuous mixer having:
a horizontal mixer vessel having a horizontal longitudinal axis, wherein the impeller is located within the vessel; and
a solids and liquids feed system comprising:
(a) a liquids inlet port for the introducing of the liquids and a solids inlet port for the feeding of the solids, or
(b) a combined liquids and solids inlet port for the introducing of the liquids and the feeding of the solids;
a perlite inlet port for the adding of the expanded perlite;
an outlet port for discharging the slurry,
wherein the outlet port discharges the slurry in a direction perpendicular to the horizontal longitudinal axis, or
horizontal along the horizontal longitudinal axis, or
parallel to the horizontal longitudinal axis;
wherein the perlite inlet port is downstream of the solids and liquids feed system.

3. The method of claim 1, wherein the liquids inlet port is upstream or downstream of the solids inlet port.

4. The method of claim 1, wherein the liquids inlet port and the solids inlet port are at the same point relative to the horizontal longitudinal axis.

5. The method of claim 2, wherein the mixer further comprises an air entraining agent inlet port for adding to the slurry in the mixer an air entraining agent.

6. The method of claim 1, further comprising adding an air entraining agent at 5-60 vol % based on the binder composition to the slurry.

7. The method of claim 1, wherein the pozzolanic material comprises finely ground silicate or aluminosilicate material reactive with calcium hydroxide and water to form calcium silicate hydrates.

8. The method of claim 1, wherein the solids further comprise lightweight aggregate.

9. The method of claim 1, wherein the reactive powder comprises about 10-40 wt. % cement, about 30-75 wt. % stucco, and about 5-30 wt. % pozzolanic material.

10. The method of claim 8, wherein the lightweight aggregate:reactive powder weight ratio is 0.01-1.75:1.00.

11. The method of claim 1, wherein the pozzolanic material comprises one or more of the group consisting of fly ash, natural pozzolan, ground granulated blast furnace slag, calcined clays, and silica fume.

12. The method of claim 1, wherein the optional additives comprise one or more of the group consisting of accelerators, retarders, and dispersants.

13. The method of claim 1, wherein the optional additives are Accelerators (0-1.5), retarders (0-1), and dispersants/plasticizers (0.1-1), as a percentage weight of the reactive powders.

14. The method of claim 1, wherein the mixing step has a reactive powder:liquids weight ratio of 100:40-80.

15. The method of claim 1, wherein the mixing temperature is 50-90° F.

16. The method of claim 1, wherein the expanded perlite:reactive powder weight ratio is 0.05-0.15:1.00.

17-19. (canceled)

20. A binder composition made by the method of claim 1.

21. A method of providing a board product comprising the method of claim 1 and further comprising applying the binder composition in a continuous production line to form the board product.

22. A method of providing a board product comprising the method of claim 1 and further comprising setting the slurry to form the product having a product density of 30 to 120 pcf.

23. A cement board made from the method of claim 21.
